(19) United States
(12) Patent Application Publication
(10) Pub. No.: US 2008/0031232 A1
(43) Pub. Date: Feb. 7, 2008

(54) Web services and plug-in framework in VOIP environment

(75) Inventors: Richard W. Shea, Maynard, MA (US); William C. Der, Dunstable, MA (US); Marc A. Greenberg, Holliston, MA (US); Fergal Glynn, Medford, MA (US); Brian Silver, North Reading, MA (US)

Correspondence Address: LAHIVE & COCKFIELD, LLP, ONE POST OFFICE SQUARE, BOSTON, MA, 02109-2127, US

(73) Assignee: BlueNote Networks, Inc., Tewksbury, MA (US)

(21) Appl. No.: 11/890,169

(22) Filed: Aug. 2, 2007

Related U.S. Application Data
(60) Provisional application No. 60/835,338, filed on Aug. 3, 2006.

(51) Int. Cl. H04L 12/66

(52) U.S. Cl. 370/352

(57) ABSTRACT

A remote plug-in framework is provided in a VoIP (Voice over Internet Protocol) environment. One or more remote plug-ins may communicate with the call control engine of the VoIP environment. The remote plug-ins may provide a customized call processing logic so that a user can implement a customized call processing logic or add new services to the VoIP environment without changes in the call control engine of the VoIP environment. In an embodiment, the remote plug-ins may be provided using Web services.

### RELATED APPLICATION

This application claims priority to U.S. Provisional Patent Application Ser. No. 60/835,338, filed Aug. 3, 2006, the contents of which are hereby incorporated by reference.

### FIELD OF THE INVENTION

The present invention relates generally to a Voice over Internet Protocol (VoIP) environment, and more particularly to a method, system and medium for providing Web services and plug-in framework in the VoIP environment.

### BACKGROUND OF THE INVENTION

Voice over Internet Protocol (VoIP) is a technology that allows a user to conduct telephone calls using an Internet connection rather than a traditional analog telephone connection. With VoIP the caller's voice signal is converted into a digital signal carried by IP packets that travel over the Internet or other network. The digital signal is then converted back into a voice signal at the other end so that the caller can speak with a called party. VoIP uses the Internet as the transmission medium for telephone calls by sending voice data in packets using IP rather than by traditional circuit transmissions of the Public Switched Telephone Network (PSTN).

The World Wide Web is used for application to application communications. The programmatic interfaces made available to the applications are referred to as Web services. Web services may be available from a business's Web server for Web users or other Web-connected applications. Web services are not tied to any one operating system or programming language. For example, JAVA can talk with PERL, and WINDOWS applications can talk with UNIX applications. Web services can be internal over an intranet or external over the Internet. Since Web services are increasingly used for application to application communications, it is desired to use the Web services in order to provide customized services in a VoIP environment.

### SUMMARY OF THE INVENTION

The present invention provides a remote plug-in framework in a VoIP (Voice over Internet Protocol) environment. The present invention allows one or more remote plug-ins to communicate with the call control engine of the VoIP environment. The remote plug-ins may provide a customized call processing logic or service so that a user can implement or add a customized call processing logic or service in the VoIP environment without changes in the call control engine of the VoIP environment. In an embodiment, the remote plug-ins may be provided using Web services.

In an embodiment, the call control engine may provide third party call control in which a call can be established between two endpoints in response to a request from a third party. In the third party call control, the call control engine sits in the middle of the call and performs requested actions on the fly. The plug-in may request the call control engine to establish a call at a time in the future. The plug-in may also request the call control engine to establish multiple calls between two endpoints concurrently. In this case, the plug-in may pass in a list of endpoints for which a call should be created.

In accordance with another aspect of the present invention, a computer-implemented method is provided for customizing a call processing logic in a VoIP environment. The method provides a remote plug-in in the VoIP environment, and enables the remote plug-in to communicate with the VoIP environment to customize the call processing logic of the VoIP environment.

In accordance with another aspect of the present invention, a medium is provided for holding computer executable instructions for customizing a call processing logic in a VoIP environment. The instructions provide a remote plug-in in the VoIP environment, and enable the remote plug-in to communicate with the VoIP environment to customize the call processing logic of the VoIP environment.

In accordance with one aspect of the present invention, a system is provided for customizing a call processing logic in a VoIP environment. The system includes a VoIP network for transmitting a call in the VoIP environment. The system also includes a remote plug-in to the VoIP environment for customizing the call processing of the VoIP environment, wherein the remote plug-in provides a call processing logic by which calls are processed in the VoIP environment.

### BRIEF DESCRIPTION OF THE DRAWINGS

The aforementioned features and advantages, and other features and aspects of the present invention, will become better understood with regard to the following description and accompanying drawings, wherein:

FIG. 1 depicts an exemplary VoIP environment suitable for practicing the illustrative embodiment of the present invention;

FIG. 2 shows an exemplary computing device for implementing the illustrative embodiment of the present invention;

FIG. 3 shows exemplary applications that are part of the VoIP environment in the illustrative embodiment;

FIG. 4 shows an exemplary interface between the remote plug-in and the session control depicted in FIGS. 2 and 3;

FIG. 5 shows an exemplary configuration in which a call is set up between calling and called parties by the call control engine depicted in FIG. 4;

FIG. 6 is a flow chart showing an exemplary operation of the illustrative embodiment depicted in FIG. 5;

FIG. 7 is a flow chart showing an exemplary operation of the configuration depicted in FIG. 4; and

FIG. 8 is a flow chart showing another exemplary operation of the configuration depicted in FIG. 4.

### DETAILED DESCRIPTION

The illustrative embodiment of the present invention provides a remote plug-in framework in a VoIP (Voice over Internet Protocol) environment where an Internet connection is used as a call transmission media. In the illustrative embodiment, the remote plug-ins are provided using Web services. Those of ordinary skill in the art will appreciate that the Web services are illustrative and the remote plug-ins may be provided using other technologies, such as client-server models and software-oriented architecture (SOA), in other embodiments.

SOA is an approach to build distributed systems that deliver application functionality as services to end-user applications or to build other services. SOA can be based on Web services, but it is not limited to Web services. Designing distributed applications using SOA may expand the use of Web services from simple client-server models to systems of arbitrary complexity.

The illustrative embodiment allows one or more remote plug-ins to communicate with the call control engine of the VoIP environment. The remote plug-in may provide a customized call processing logic or service by which calls are processed in the VoIP environment. A user can implement a customized call processing logic or service for the VoIP environment using the remote plug-in without changes in the call control engine of the VoIP environment. Using the Web service plug-in, the user may also add new services to the call processing logic of the VoIP environment.

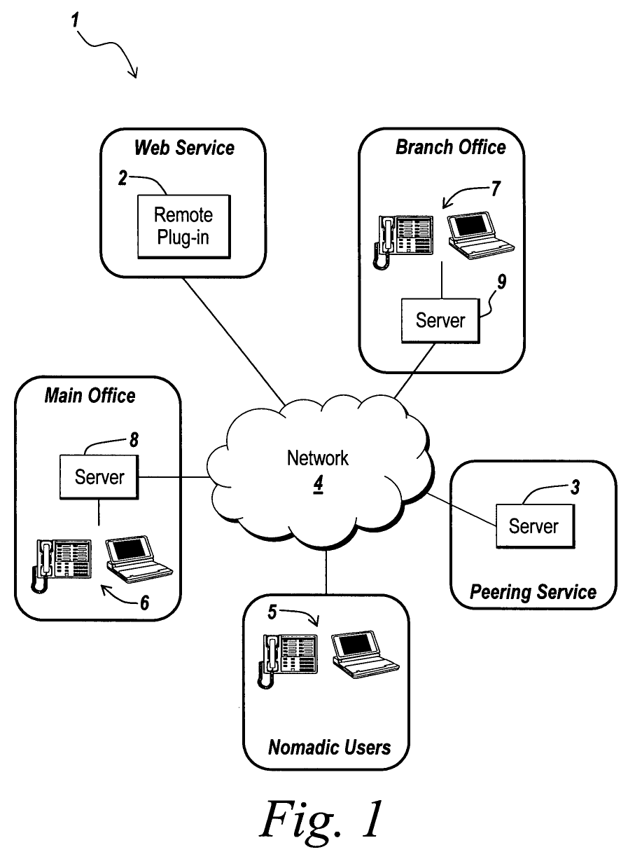

FIG. 1 is an exemplary VoIP environment 1 suitable for practicing the illustrative embodiment of the present invention. The VoIP environment 1 may include one or more servers 3, 8 and 9 coupled to clients 5, 6 and 7 via a call transmission network 4. The call transmission network 4 forwards a call placed by a calling party to its destination where a called party is located. The illustrative embodiment uses the Internet for the call transmission network. In other embodiments, the call may be transmitted through intranet, LAN (Local Area Network), WAN (Wide Area Network), MAN (Metropolitan Area Network), wireless network (e.g., using IEEE 802.11 and Bluetooth), and the combination thereof.

In the VoIP environment 1, the clients 5, 6 and 7 may reside on a phone or a computer to enable the calling party to place a call or the called party to receive a call. In the illustrative embodiment, when a user places a call on the client 6 in the main office, the server 8 may direct the call to another user in the main office or to a nomadic user 5 on the network 4. In another instance the servers 8 and 9 may direct the call to the client 7 in the branch office. The call may be directed using a server 3 in a peering service provider, such as VONAGE™. The server may set up a session between the clients using Session Initiation Protocol (SIP). SIP is a protocol for initiating, modifying, and terminating an interactive user session that involves multimedia elements, such as video, voice, instant messaging, online games, and virtual reality. SIP allows the use of network elements, such as Proxy Servers and User Agents, to provide familiar telephone-like operations: dialing a number, causing a phone to ring, hearing ringback tones or a busy signal. SIP acts as a carrier for the Session Description Protocol (SDP), which describes the media content of the session, such as the IP ports to use, the codec being used etc. SIP is used in setting up and tearing down a session between the clients 6 and 7 in the illustrative embodiment. Those of ordinary skill in the art will appreciate that SIP is an illustrative signaling protocol and the present invention may employ a different protocol, such as H.323 protocol, in other embodiments.

After the session is set up between the clients, the content of the call including voice and/or video signals are transmitted over the Internet using Real-time Transport Protocol (RTP). RTP defines a standardized packet format for the real-time delivering of audio and video signals over the Internet. RTP carries the actual voice or video content of the call in real-time. In the illustrative embodiment, the term “session” is used to refer to the packet stream of the RTP.

The illustrative embodiment also provides Web services that may available from a business's Web server for Web users or other Web-connected plug-ins 2. Web services utilize a set of technologies, such as Simple Object Access Protocol (SOAP), Web Services Definition Language (WSDL) and Universal Description, Discovery and Integration (UDDI), as a means to securely and remotely gain access to the function of another application via the network 4. SOAP is used to transfer the data, WSDL is used for describing the services available and UDDI is used for listing what services are available. When the remote plug-ins 2 are registered with the servers 3, 8 and 9, the plug-ins 2 may communicate with the servers 3, 8 and 9 so that new call services can be added to the VoIP environment 1.

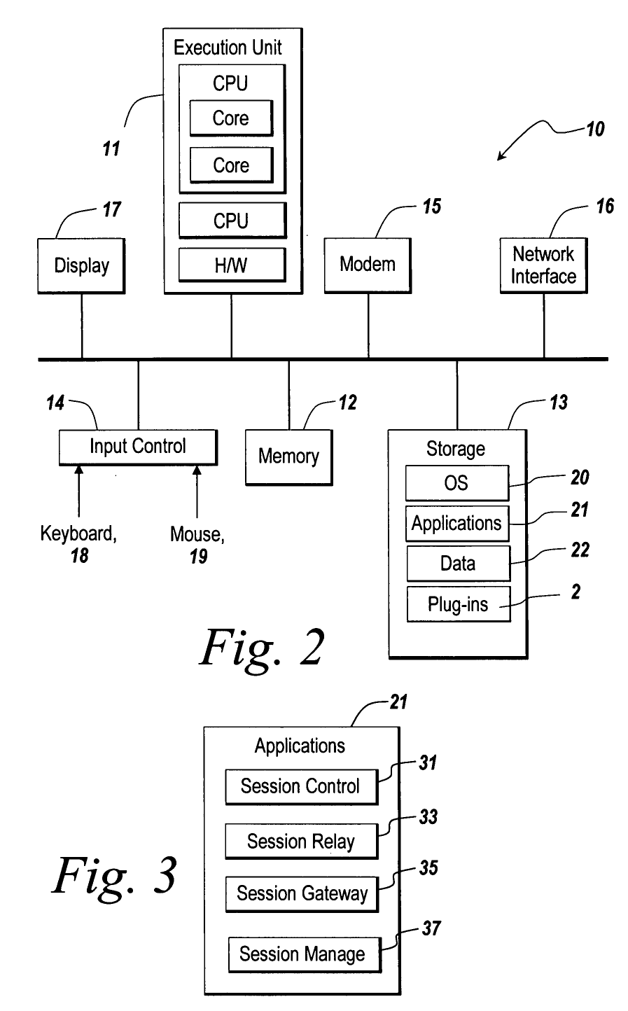

FIG. 2 is an exemplary computing device 10 suitable for practicing the illustrative embodiment of the present invention. One of ordinary skill in the art will appreciate that the computing device 10 is intended to be illustrative and not limiting of the present invention. The computing device 10 may take many forms, including but not limited to a workstation, server, network computer, quantum computer, optical computer, bio computer, Internet appliance, mobile device, a pager, a tablet computer, and the like.

The computing device 10 may be electronic and include an execution unit 11, memory 12, storage 13, an input control 14, a modem 15, a network interface 16, a display 17, etc. The execution unit 11 controls each component of the computing device 10 to provide the VoIP environment 1. The memory 12 temporarily stores instructions and data and provides them to the execution unit 11 so that the execution unit 11 operates the computing device 10.

Optionally, the computing device 10 may include multiple Central Processing Units (CPUs) for executing software loaded in the memory 12, and other programs for controlling system hardware. Each of the CPUs can be a single or multiple core processor. The code loaded in the memory 12 may run in a virtualized environment, such as in a Virtual Machine (VM). Multiple VM's may be resident on a single processor. Also, part of the application could be run in hardware, for example, by configuring a field programmable gate array (FPGA) or creating an application specific integrated circuit (ASIC).

The storage 13 usually contains software tools for applications. The storage 13 includes, in particular, code 20 for the operating system (OS) of the device 10, code 21 for applications running on the operation system to provide the VoIP environment 1, and data 22. The storage 13 may include plug-in applications 2 in the Web servers. The applications will be described below in more detail with reference to FIG. 3. Those of ordinary skill in the art will appreciate that the application can be stored in the memory 12 as well, much like the data, and even the OS, or they can be stored on the network described below with reference to FIG. 1.

The input control 14 may interface with a keyboard 18, a mouse 19, and other input devices. The computing device 10 may receive input data through the input control 14. The computing device 10 may display on the display 17 user interfaces for a user to interact with the VoIP environment 1. The modem 15 and network interface 16 enables the client 6 and 7 to communicate with each other through the servers 8 and 9 in the network 4.

FIG. 3 shows exemplary applications provided in the illustrative embodiment for the VoIP environment 1. The applications 21 may include a set of modular software components, such as session control 31, session relay 33, session gateway 35 and session manage 37, that can be combined into discrete functional packages. Examples of the applications 21 can be found in SESSIONSUITE™ from BlueNote Networks, Inc. of Tewksbury, Mass.

The session control 31 is a control agent and contains registrar and location databases. The clients 6 and 7 may register with a local session control 31 in the servers 8 and 9 so that the servers 8 and 9 can determine the locations of the clients 6 and 7. When the clients 6 and 7 are registered with the session control 31, the locations of the clients 6 and 7 are stored in the location databases in the servers 8 and 9. The session control 31 may set up or tear down the session between the clients 6 and 7 using the SIP protocol. The session control 31 may generate and maintain session detail records of a call between the clients 6 and 7.

The session relay 33 provides the media based services, such as transcoding, recording, lawful intercept, etc. The session relay 33 may supply compression and transcoding and support a plurality of codecs including G.711, G729a, G.729b, and GSM for voice, and H.263 and H.264 for video. The session relay 33 may also provide recording services for recording the session between the clients 6 and 7. The call recordings may be stored locally on the session relay 33.

The session gateway 35 bridges a VoIP network and traditional PSTN/PBX infrastructures, and allows a user to place and receive a call with a PBX user or a user of the PSTN network. The session gateway 35 works with standard-based third party analog and digital line adaptors, supporting a variety of interfaces including ISDN, T1/E1 Channel Associated Signaling (CAS), PBX inter-working and Foreign Exchange Office/Subscriber (FXO/S) incorporation. With the session gateway 35, a user can migrate to VoIP, while using the traditional PBX and maintaining communications with the public telephone infrastructure.

The session manage 37 manages the application components. The session manage may be a Web-based application for managing the VoIP services, resources, sessions, users and clients. The session manage may provide a common Web Browser interface for managing the application components and integrating fault, configuration, performance, and security management for the VoIP functions. The session manage may allow a user to manage call handling and voice mail features through a secure Web Browser. The session manage may provide an XML/SOAP interface for integration with third-party or customer-developed management applications and systems. The session manage 37 may provide an interface for displaying session detail records 23 to the user.

FIG. 4 shows an exemplary interface between the remote plug-in and the session control. Although the interface is provided in the session control 31 in the illustrative embodiment, the interface may be provided in the session manage 37 in a different embodiment. When a remote plug-in 47 is registered with the session control 31, an interface 43 is dynamically provided in the session control 31. The interface 43 may include an object acting as a proxy agent representing the remote plug-in 47 within the session control 31. The proxy agent may include the attributes of the plug-in 47, such as an identifier of the plug-in. When multiple plug-ins 47 and 49 are registered, multiple interfaces 43 and 45 may be provided to support the multiple plug-ins 47 and 49.

The interfaces 43 and 45 acts as a conduit for the delivery of data between the local call control engine 41 and the plug-ins 47 and 49. The session control 31 may provide APIs that enable the plug-ins 43 and 45 to interact with the call control engine 41. The interfaces 43 and 45 may use simple object access protocol (SOAP) to transfer data between the call control engine 41 and the plug-ins 47 and 49. SOAP is a protocol for exchanging XML-based messages over a computer network, normally using HTTP. SOAP forms the foundation layer of the Web services, providing a basic messaging framework that more abstract layers can build on. The interfaces 43 and 45 may use the APIs of the plug-ins 47 and 49 to transfer data to and from the plug-ins 47 and 49.

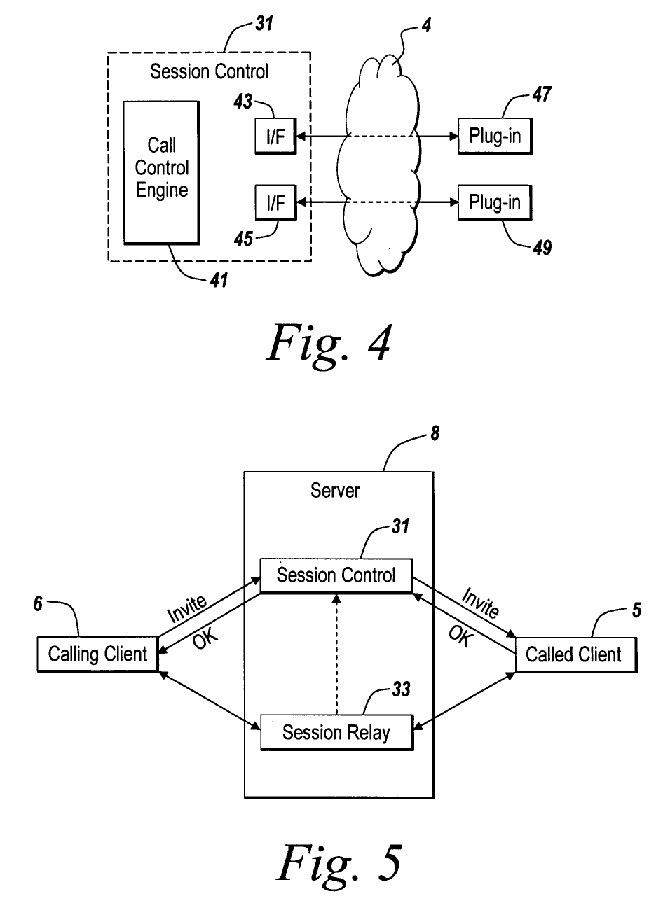

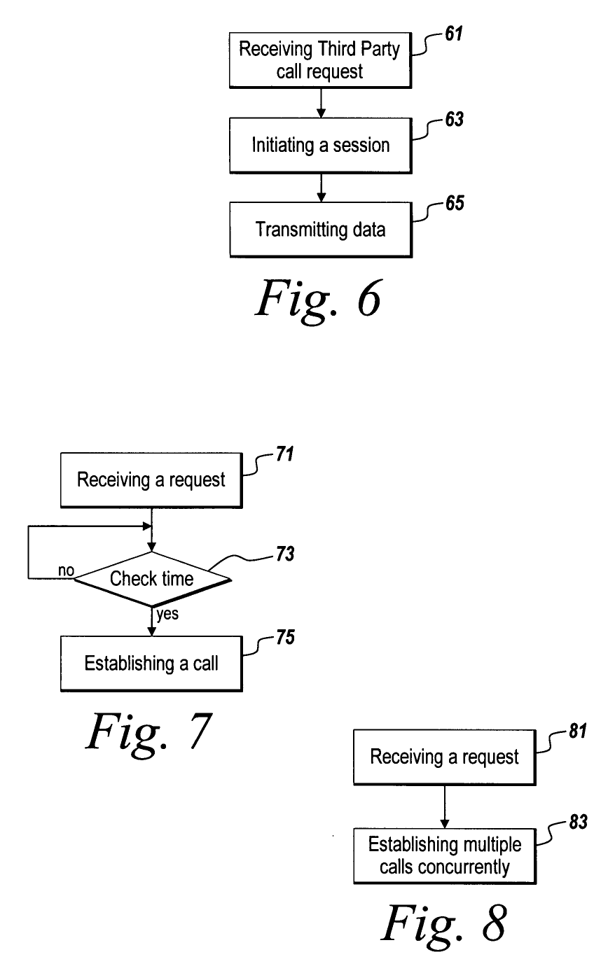

FIG. 5 shows an exemplary configuration in which a call is set up between the clients 5 and 6 by the call control engine 41 in the illustrative embodiment, and FIG. 6 is a flow chart showing an exemplary operation of the illustrative embodiment depicted in FIG. 5. In the illustrative embodiment, a third party may request the session control 31 to establish a call between the clients 5 and 6. The session control 31 coordinates the establishment of the call between the client 5 and 6. The session control 31 first contacts the calling party. After the calling party answers, the session control contacts the called party. After the called party answers, the session control connects the media path between two parties.

In the illustrative embodiment, the clients 5 and 6 may register with the session control 31 in the server 8. When a third party requests a call to be established between the clients 5 and 6 (step 61), the call control engine 41 sets up a session between the clients 5 and 6 using the SIP protocol (step 63). The session control 31 checks the location database in the server 8 to authenticate the users and to determine the location of the clients 5 and 6. The session control 31 sends an INVITE message to the client 6 without the session description protocol (SDP). The client 6 sends back an OK message with the SDP of the client 6. The session control 31 then sends an INVITE message to the client 5, and the client 5 sends an OK message to the session control 31 with the SDP of the client 5. The session control 31 sends a RE-INVITE message to the client 6, and the client sends an OK message to the session control 31. After a call is established between the client 5 and 6, the clients 5 and 6 may send voice and/or video streams through the session relay 33 in the server 8 (step 65). For example, the client 6 may send the voice and/or video streams to the session relay 33, and the session relay 33 may forward the streams to the client 5. In a similar fashion, the client 5 may send the voice and/or video streams to the session relay 33, and the session relay 33 may forward the streams to the client 6.

FIG. 7 is a flow chart showing an exemplary operation of the configuration depicted in FIG. 4. In the illustrative embodiment, the plug-in 47 provides an application for establishing a call between two parties, as described above with reference to FIGS. 5 and 6, at a time in the future. The session control 31 may receive a request from the plug-in 47 through the interface 43 for establishing a call between two parties at a time in the future (step 71). The request may include information about the parties and the time when the call is to be established. The call control engine 41 checks if it is time to call (step 73). When it is time to call, the call control engine 41 establishes a call between the specified parties as described above with reference to FIGS. 5 and 6 (step 75). This service may provide the advantages of actual establishment of, for example, a conference call at a time in the future rather than providing a reminder of the conference to the parties. If a party does not answer to the call, the service may leave a message to the party that a conference call has been missed.

FIG. 8 is a flow chart showing another exemplary operation of the configuration depicted in FIG. 4. In the illustrative embodiment, the plug-in 49 provides an application for establishing multiple calls concurrently, each call being established between two parties, as described above with reference to FIGS. 5 and 6. It allows APIs to concurrently establish sessions between multiple end points (step 81). A call request may include information about the parties. For example, the request may pass in a list of endpoints for which calls should be established. The request may take the following API command.

createSession({a,x}, {b,y}, {c,y}, {d,y})

In response to the request, the call control engine 41 sets up a call between the parties a and x, sets up a call between parties b and y, sets up a call between parties c and y, and sets up a call between parties d and y, as described above with reference to FIGS. 5 and 6 (step 83). If the party y has the capabilities to auto answer and mix the audio streams of the three sessions, then a three-way call can be established among the parties b, c and d. In this case, the session control does not need to have knowledge about the capabilities of endpoints being invited to the session.

Certain embodiments of the present invention are described above. It is, however, expressly noted that the present invention is not limited to these embodiments, but rather the intention is that additions and modifications to what is expressly described herein also are included within the scope of the invention. Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. A computer-implemented method for customizing a call processing in a voice over Internet protocol (VoIP) environment, the method comprising the steps of:
providing a remote plug-in to the VoIP environment,
enabling the remote plug-in to communicate with the VoIP environment to customize the call processing of the VoIP environment.

2. The method of claim 1, wherein the remote plug-in provides a call processing logic by which a processing of calls is executed in the VoIP environment.

3. The method of claim 1, wherein the remote plug-in is provided using Web services.

4. The method of claim 1, further comprising the step of:
providing an interface between the remote plug-in and the VoIP environment so that the remote plug-in communicates with the VoIP environment through the interface.

5. The method of claim 1, wherein the interface is provided using simple object access protocol (SOAP).

6. The method of claim 1, wherein a call is initiated using a Session Initiation Protocol (SIP) in the VoIP environment.

7. The method of claim 6, wherein data of the call is transmitted using a Real Time Transport Protocol (RTP).

8. The method of claim 1, wherein the remote plug-in enables the VoIP to set up a call at a future time.

9. The method of claim 1, wherein the remote plug-in enables the VoIP to set up multiple calls concurrently between two endpoints in the VoIP environment.

10. A medium holding computer executable instructions for customizing a call processing in a voice over Internet protocol (VoIP) environment, the instructions for:
providing a remote plug-in to the VoIP environment; and
enabling the remote plug-in to communicate with the VoIP environment to customize the call processing of the VoIP environment.

11. The medium of claim 10, wherein the remote plug-in provides a call processing logic by which a processing of calls is executed in the VoIP environment.

12. The medium of claim 10, wherein the remote plug-in is provided using Web services.

13. The medium of claim 10, further comprising:
providing an interface between the remote plug-in and the VoIP environment so that the remote plug-in communicates with the VoIP environment through the interface.

14. The medium of claim 13, wherein the interface is provided using simple object access protocol (SOAP).

15. The medium of claim 10, wherein a call is initiated using a Session Initiation Protocol (SIP) in the VoIP environment.

16. The medium of claim 15, wherein data of the call is transmitted using a Real Time Transport Protocol (RTP).

17. The medium of claim 10, wherein the remote plug-in enables the VoIP to set up a call at a future time.

18. The medium of claim 10, wherein the remote plug-in enables the VoIP to set up multiple calls concurrently between two endpoints in the VoIP environment.

19. A system for customizing a call processing in a VoIP environment, the system comprising
a VoIP network for transmitting a call in the VoIP environment,
a remote plug-in to the VoIP environment for customizing the call processing of the VoIP environment, wherein the remote plug-in provides a call processing logic by which a processing of calls is executed in the VoIP environment.

20. The system of claim 19, wherein the remote plug-in is provided using Web services.

21. The system of claim 19, further comprising:
an interface between the remote plug-in and the VoIP environment so that the remote plug-in communicates with the VoIP environment through the interface.

22. The system of claim 21, wherein the interface is provided using simple object access protocol (SOAP).

23. The system of claim 19, wherein a call is initiated using a Session Initiation Protocol (SIP) in the VoIP environment.

24. The system of claim 23, wherein data of the call is transmitted using a Real Time Transport Protocol (RTP).

25. The system of claim 19, wherein the remote plug-in enables the VoIP to set up a call at a future time.

26. The system of claim 19, wherein the remote plug-in enables the VoIP to set up multiple calls concurrently between two endpoints in the VoIP environment.

27. The system of claim 19, wherein the VoIP network comprises the Internet.
